(19) United States
(12) Patent Application Publication
(10) Pub. No.: US 2017/0267233 A1
(43) Pub. Date: Sep. 21, 2017

(54) METHOD FOR AUTONOMOUS VEHICLE PARKING

(71) Applicant: Cruise Automation, Inc., San Francisco, CA (US)

(72) Inventors: Gautier Minster, San Francisco, CA (US); Peter Gao, San Francisco, CA (US); Wei Mou, San Bruno, CA (US)

(21) Appl. No.: 15/458,152

(22) Filed: Mar. 14, 2017

Related U.S. Application Data
(60) Provisional application No. 62/308,708, filed on Mar. 15, 2016.

(51) Int. Cl. B60W 30/06; G06Q 10/02; G06Q 20/36; G05D 1/00

(52) U.S. Cl. CPC B60W 30/06; G05D 1/0088; G06Q 10/02; G06Q 20/36; B60W 2420/42; B60W 2420/52; G06Q 2240/00

(57) ABSTRACT

Systems and methods for autonomous vehicle parking includes: identifying parking parameters for parking an autonomous vehicle; receiving parking space data of one or more parking spaces; identifying a parking space of the one or more parking spaces for parking the autonomous vehicle; determining autonomous vehicle controls for controlling the autonomous vehicle to park at a parking space associated with the parking space data; implementing the autonomous vehicle controls for parking the autonomous vehicle in the parking space.

### CROSS-REFERENCE TO RELATED APPLICATIONS

This application claims the benefit of U.S. Provisional Application Ser. No. 62/308,708, filed on 15 Mar. 2016, which is incorporated in its entirety by this reference.

### TECHNICAL FIELD

This invention relates generally to the vehicle automation field, and more specifically to new and useful methods for parking an autonomous vehicle.

### BACKGROUND

Vehicle automation has been suggested as a means for addressing this pressing issue almost as long as cars have been in existence—experiments on autonomy in cars have been conducted since at least the 1920s. Only recently, though, has computer technology advanced enough to make true vehicle automation possible. While teaching autonomous vehicles to safely navigate the road and obey driving regulations is a significant challenge, autonomous vehicles in cities must further surmount an equally daunting task, one that frequently conquers even the brightest of human minds—figuring out where and how to park legally.

Thus, there is a need in the vehicle automation field to create methods for parking an autonomous vehicle. This invention provides such new and useful methods.

### BRIEF DESCRIPTION OF THE FIGURES

FIG. 1 is a chart representation of a method of a preferred embodiment;

FIG. 2 is a chart representation of receiving parking space data of a method of a preferred embodiment;

FIG. 3 is an example view representation of an expert parking interface;

FIG. 4 is an example view representation of an augmented reality passenger parking interface; and

FIG. 5 is a diagram representation of a system of a preferred embodiment of the present application.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### Overview

Along with the dramatic increases in innovation in the autonomous vehicle space, there has been an equal amount and, if not, greater amount of additions of autonomous vehicles to public streets for testing and/or actual use. The addition of these great number of autonomous vehicles into current traffic raises a number of questions relating to the temporary to permanent storage, including the temporary and permanent parking, of these vehicles. While autonomous vehicles continue to advance in identifying objects and locations (e.g., curbs, unobstructed lanes, and the like) for making temporary stops for the purpose of picking up a passenger or the like, the technical capabilities for identifying and obtaining a temporary or permanent parking space by an autonomous vehicle has been lagging.

Additionally, depending on the city, town, or other municipal area, the markings and instruments used to identify parking locations may vary greatly. For instance, in some areas, available public parking areas may be designated solely with markings on the ground and in other areas, a public space may be designated by signage or other instruments displayed above ground and next to the associated parking space. In other instances, indications of an available parking space may be made on a curb or other permanent structure adjacent to the available parking space. Thus, the means and method for indicating an available parking area may vary greatly across different cities and jurisdictions. These variations can make it difficult for an autonomous vehicle to identify and locate a parking space.

Thus, parking is a difficult challenge for vehicles, especially in urban areas where parking space availability is low and parking is subject to a web of byzantine regulations. Autonomous vehicles face an additional challenge over traditional vehicles—since a human is not necessarily available to provide parking guidance, an autonomous vehicle must be able to either successfully interpret the availability and suitability of a parking space (e.g., by reading parking signs) independently or efficiently request human guidance. Fortunately, autonomous vehicles have an advantage; the advanced sensing capability and virtually unlimited attention capacity of autonomous vehicles enables them to find parking spots quickly and without detracting from driving ability of the autonomous vehicle. Further, the ability of multiple autonomous vehicles to communicate enables vehicles to constantly collect information about parking, providing a huge informational advantage; even vehicles not actively searching for parking can transmit parking availability as they travel down a street.

Accordingly, the embodiments of the present application are directed to systems and methods for identifying temporary and/or permanent parking areas by an autonomous vehicle including systems and methods for facilitating a transaction for an available parking space. These systems and methods may increase the ability of the autonomous vehicles to be utilized efficiently during peak and off-peak times, meet ridership demands, satisfy predetermined maintenance or similar schedules, and the like.

### 1. System for Autonomous Vehicle Parking

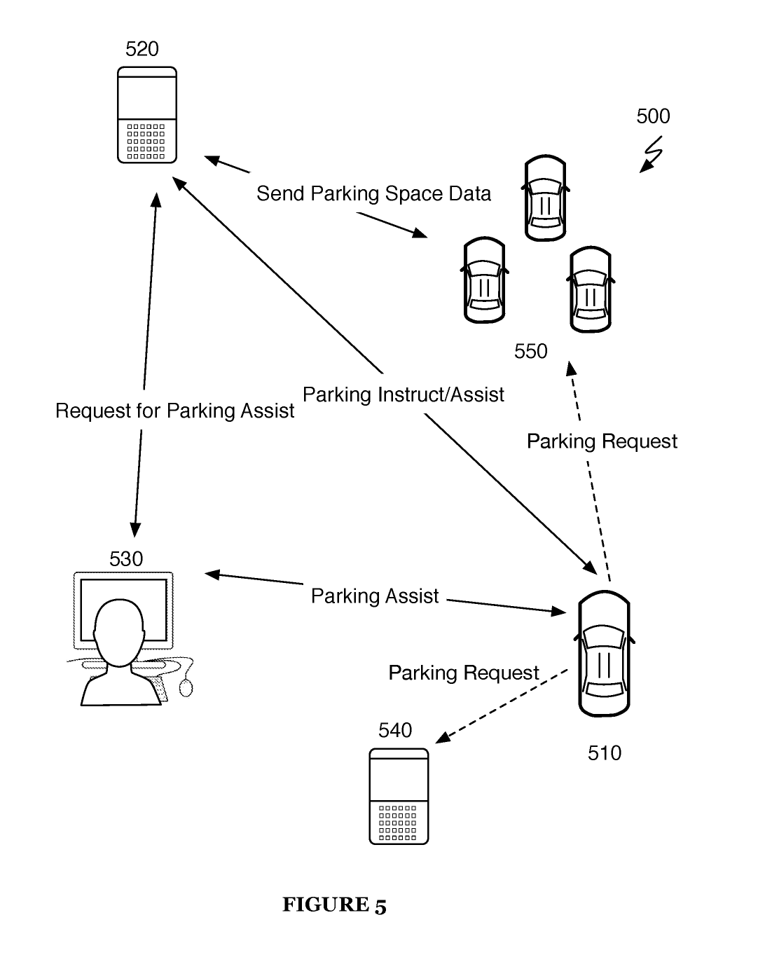

As shown in FIG. 5 a system 500 for autonomous vehicle parking includes an autonomous vehicle 510, a vehicle coordinator 520, optionally a remote expert interface 530, an autonomous vehicle parking facilitation system (parking facilitator) 540, and a plurality of autonomous vehicles 550.

The system 500 functions to enable autonomous vehicle 510 to locate and/or identify an available parking space. Additionally, the system 500 functions to enable autonomous vehicle 510 to transaction to complete a transaction for obtaining or securing a parking space. For example, the vehicle routing coordinator 520 may provide instruction to the autonomous vehicle 510 to park in a specific geographic area associated with a ridesharing request or the like. In response, the autonomous vehicle 510 may transmit a parking request to a parking facilitator 540 and the plurality of autonomous vehicles 550 for assisting in identifying a parking location in the geographic area. The plurality of autonomous vehicles 550 may collect parking space information, including available parking spaces, and the parking facilitator 540 may identify any available spaces under its management and both the facilitator 540 and the plurality of autonomous vehicles 550 may transmit the parking space information to the autonomous vehicle 510. Based on the parking space data provided by the facilitator 540 and the plurality of AVs 550, as well as parking space information obtained from the sensors associated with the autonomous vehicle 510, the autonomous vehicle 510 may be able to identify one or more available spaces and locate, at least one, of the spaces for parking.

The autonomous vehicle 510 and the plurality of autonomous vehicles 550 of the system 500 are preferably fully autonomous automobiles, but may additionally or alternatively be any semi-autonomous or fully autonomous vehicle; e.g., a boat, an unmanned aerial vehicle, a driverless car, etc. The method 100 and any other method disclosed herein may be implemented using autonomous vehicle 510 and the plurality of autonomous vehicles 550 and/or any other components of the system 500.

In addition to a powertrain (or other movement-enabling mechanism), autonomous vehicles preferably include an onboard computer and a sensor suite (e.g., computer vision system, Light Detection and Ranging (LIDAR), RADAR, wheel speed sensors, GPS, cameras, etc.). The onboard computer functions to control the autonomous vehicle and processes sensed data from the sensor suite and/or other sensors in order to determine the state of the autonomous vehicle. Based upon the vehicle state and programmed instructions, the onboard computer preferably modifies or controls behavior of the autonomous vehicle.

The RADAR of the sensor suite allows for a number of detectable circumstances surrounding the autonomous vehicle. RADAR allow for the detection of depth or extra depth in the circumstances surrounding the vehicle such that when used in combination with one or more other components of the sensor, suite such as the two-dimensional views of the cameras, the autonomous vehicle is able to determine better positioning of objects surrounding the vehicle. For instance, using RADAR, the autonomous vehicle is able to determine when a curb is clear from obstruction by an object, such as another vehicle or the like, in order to determine whether it is possible to travel or park alongside the curb.

The communication interface of each autonomous vehicles functions to allow Internet and inter-vehicle communications. For example, in many autonomous vehicles a Peplink router may form part of the communication interface. The Peplink router may be a highly reliable Wi-Fi router. The Peplink router may be modified to include four cellular connection/communication chips for enabling highly reliable wireless communications (e.g., Internet communications, inter-vehicle communications, etc.) between each of the autonomous vehicles and between an autonomous vehicle and one or more servers used in system 100. In this way, a muxer is formed between the four chips such that signals from the four cellular chips may be combined into one signal over one or more shared mediums. This allows for the distribution of work between these four cellular chips to allow for the highly reliable connection. In one example, the muxer allows for bytes of a single network packet to be divided among the four cellular chips in order to a single cellular chip. If any of the four cellular chips should fail for any reason, the workload of the failed chip can be re-allocated to another of the active cellular chips or distributed (re-balanced) evenly among the remaining active cellular chips thereby allowing for continuity in communication in the event that one or more of the cellular chips fail.

The onboard computer functions to control the operations and functionality of the autonomous vehicles 510 and processes sensed data from the sensor suite and/or other sensors in order to determine states of the autonomous vehicles 510. Based upon the vehicle state and programmed instructions, the onboard computer preferably modifies or controls behavior of autonomous vehicles 510.

The onboard computer is preferably a general-purpose computer adapted for I/O communication with vehicle control systems and sensor systems, but may additionally or alternatively be any suitable computing device.

The onboard computer is preferably connected to the Internet via a wireless connection (e.g., via a cellular data connection). Additionally or alternatively, the onboard computer may be coupled to any number of wireless or wired communication systems.

Autonomous vehicles may additionally or alternatively include an external interface that functions to enable a person or other entity exterior to the autonomous vehicle to communicate or interact with the vehicle. The external input interface preferably includes one or more input devices located at or otherwise coupled to the exterior of the vehicle, but may additionally or alternatively include any input devices accessible to a person outside of the vehicle (e.g., a camera located inside a vehicle cabin, but imaging the outside of the vehicle through a window).

The external input interface is preferably substantially similar to the interface described in U.S. Provisional Patent Application No. 62/274,586, filed on 4 Jan. 2016, the entirety of which is incorporated by this reference. Additionally or alternatively, the external input interface may be any suitable interface.

The vehicle routing coordinator 520 may additionally serve as the communication hub for inter-vehicle communication. In this way, a single autonomous vehicle is not receiving signals from too many other autonomous vehicles thereby allowing the single autonomous to preserve bandwidth for effectively communicating with the routing coordinator 520. Preferably, the vehicle routing coordinator 520 comprises a geographically remote server (or distributed computing system) connected to the autonomous vehicle 510 and the plurality of autonomous vehicles 550 via an Internet connection, but may additionally or alternatively be any suitable computing system (e.g., a collection of autonomous vehicle computers working as a distributed computing system).

Additionally, the autonomous vehicle routing coordinator 520 functions to parking and routing assistance to one or more of the plurality of autonomous vehicles. The routing coordinator 520 preferably aggregates parking requests and sensor data collected by the autonomous vehicles and uses that data to generate information that may be used by the autonomous vehicle 510 to perform parking (or may be used by the autonomous vehicle routing coordinator 520 to generate parking instructions for the autonomous vehicle 510). In addition to or alternative to sensor data, the autonomous vehicle routing coordinator 520 may use vehicle parking demand data (e.g., estimated from historic and current parking requests), traffic data, construction data, event data, limitations data, user provided data, or other data to provide parking and/or routing assistance.

The parking facilitator 540 functions to communicate with the autonomous vehicle 510 and/or the vehicle coordinator 550 for the purpose of identifying available parking spaces, parking space data, and facilitate a transaction for an available parking space between the autonomous vehicle 510 or the autonomous vehicle coordinator 550 and the parking facilitator 540. In some embodiments, the parking facilitator may be a stand-alone machine near or at a parking space. The stand-alone machine may be an electronic parking device (e.g., electronic parking meter or kiosk) having a computer processor, an electronic wallet, and payment processing capabilities. The parking facilitator 540 may be an autonomous parking facilitator with the capabilities to facilitate an entire transaction with an autonomous device, which includes receiving or initiating a parking request with an autonomous vehicle 510 and/or autonomous vehicle coordinator 550 and receiving payment information for securing a parking space managed by the parking facilitator 540 or owned by an entity associated with the parking facilitator 540. In some embodiments, the parking facilitator may be a remote server that is capable of establishing communication directly with or indirectly via the autonomous vehicle 510 and/or the autonomous vehicle coordinator 540 for the purposes of facilitating parking of the autonomous vehicle.

Additionally, or alternatively, the parking facilitator 540 may include a virtual parking agent residing locally within electronic parking devices (e.g., electronic parking meters, kiosks, and the like). The virtual parking agent preferably comprises software having instructions executable by a computer processor or the like at the electronic parking devices. The virtual parking agent may be capable of facilitating a parking transaction between itself and an autonomous vehicle 510. The virtual parking agent may also be capable of interacting a passenger or intended passenger of the autonomous vehicle for the purposes of responding to inquiries, performing an active search of available spaces for a parking request, and facilitating a payment transaction and the like.

The system 500 may optionally include a user interface 560 (not shown) that enables an autonomous vehicle user (e.g., a passenger, or a ridesharing platform user who may not be a passenger) to interact with and provide information to an autonomous vehicle 510. The user interface 560 is preferably a web interface or a native application interface accessible through a mobile electronic device (e.g., a smartphone, a laptop computer, etc.) but may additionally or alternatively be any interface through which a user may communicate with an autonomous vehicle 510, the parking facilitator 540, or a system that affects control of an autonomous vehicle 510 (e.g., the autonomous vehicle routing coordinator 520). For example, a user interface 560 may be a touchscreen in an autonomous vehicle 510. The user interface 560 is preferably any interface capable of receiving user input as described in the section on the method 100. Additionally or alternatively, the user interface 560 may be any interface capable of influencing autonomous vehicle parking; for instance, the user interface 560 maybe the user interface of a ridesharing platform that affects ridesharing vehicle demand.

### 2. Method for Autonomous Vehicle Parking

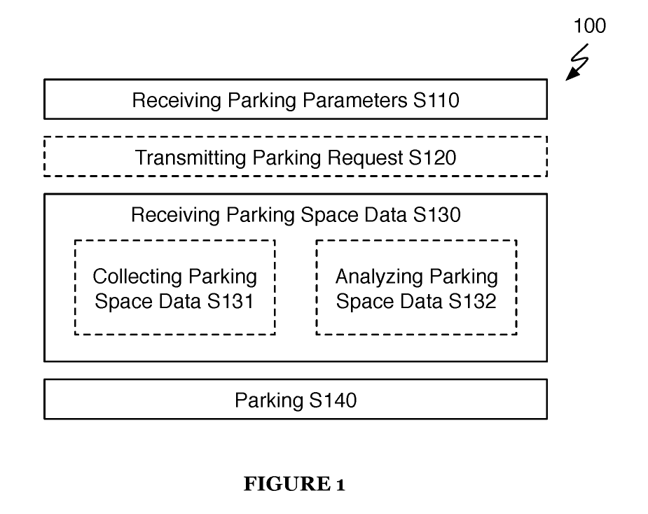

A method 100 for autonomous vehicle parking includes receiving parking parameters S110, receiving parking space data S130, and parking S140, as shown in FIG. 1. The method 100 may additionally include transmitting a parking request S120.

The method 100 functions to enable an autonomous vehicle to find parking spaces meeting certain criteria (i.e., parking parameters received in S110) based on parking space data received (in S130) from the sensors of the autonomous vehicle or from other data (such as sensor data from other autonomous vehicles), and then automatically parking (S140) based on the parking space data. The method 100 may additionally or alternatively enable the autonomous vehicle to transmit a parking request (S120) that may, for instance, result in transmission of parking space data to the autonomous vehicle. As another example, S120 may function to confirm or negotiate access for parking spaces where parking may be restricted (e.g., parking spaces that must be paid for). Note that parking spaces may include any area in which a vehicle may park lawfully or with permission of an appropriate entity associated with or owner of the parking spaces.

S110 includes receiving and/or identifying parking parameters. Generally, S110 functions to provide criteria used to locate and/or evaluate potential parking spaces for one or more autonomous vehicles. Parking parameters for an autonomous vehicle may be generated remotely (e.g., at a remote vehicle coordinator) and subsequently transmitted to the autonomous vehicle over a network, such as the Internet, mesh network, a long-range or short-range communication system, and the like. For instance, in some embodiments, the parking parameters and related parking instructions are generated by a central autonomous vehicle coordinating authority. The parking parameters may be generated by the vehicle coordinator on various basis including when the vehicle coordinator receives one or more pickup or ride requests via a ridesharing platform associated with the autonomous vehicle. Additionally, or alternatively, the parking parameters may be generated based on predetermined schedules for parking and/or predetermined vehicle operational schedule or maintenance schedule.

In the instance that the vehicle coordinator receives a pickup or ride request, the pickup or ride request may include pickup related data including rider preferences, pickup location, vehicle type requested, date and time of the requested pickup, and the like. The vehicle coordinator preferably processes the pickup data associated with the pickup request to determine whether it may be necessary for an autonomous vehicle to park temporarily or for a more permanent time prior to or after the pickup the request. For instance, if the vehicle coordinator is aware that the pickup request is during a high traffic period (e.g., rush hour) the vehicle coordinator may determine that it is necessary to schedule an autonomous vehicle to be located at the pickup location associated with the pickup request in advance of the requested pickup time to avoid delays in satisfying an intended passenger's preferred time for pickup. In such case, the vehicle coordinator may provide to an autonomous vehicle a pickup request together with parking parameters.

Of course, a pickup or ride request may be transmitted directly from an intended passenger (e.g., via an electronic device, etc.) to the autonomous vehicle. Subsequently, the autonomous vehicle would similarly be able to process the pickup related data to determine whether parking is required prior to or after the pickup and the associated parking parameters.

As mentioned above, the parking parameters may be generated on the basis of a predetermined parking schedule. For instance, the vehicle coordinator may determine parking parameters for each autonomous vehicle in a fleet of autonomous vehicles based on the predetermined parking schedule. The predetermined parking schedule may be useful for adding and removing autonomous vehicles from traffic to accommodate for traffic or some other metric for managing autonomous vehicles. Thus, the predetermined parking schedule may identify one or more times at which it is necessary to reduce a number of autonomous vehicles in use and in some instances, provide with particularity the geographic areas and number of autonomous vehicles to be reduced therefrom. Of course, the parking schedule could also be dynamic to take into account traffic, ridership demand, autonomous vehicle maintenance requirements, and the like. Additionally, or alternatively, the autonomous vehicle itself may have stored onboard the parking schedule and generating parking parameters based thereon.

Parking parameters preferably include any information describing the parking needs or desires of an autonomous vehicle. For example, parking parameters may include parking geographic parameters (e.g., a parking space must be within some distance of an address or coordinate, a parking space must be on a particular street, it is preferable for a parking space to be in a particular neighborhood or area, a parking space must be accessible by disabled individuals), parking time parameters (e.g., parking start time, parking end time, parking duration), parking accessibility parameters (e.g., must be able to access the vehicle during the day, must be able to have repeated access), parking cost parameters (e.g., must be below a certain cost per hour), parking space physical parameters (e.g., space must be a certain size or shape), parking amenity parameters (e.g., charging port available), parking space type parameters (e.g., commercial vehicle spaces) any parameters related to parking (e.g., parking space corresponds to a particular parking permit, parking space is owned by a particular company or individual, parking space is legal to park in, space may only be used for short term pauses because it is not an official parking space), and/or ability to wirelessly or electronically transact with a parking space or parking agent to acquire a parking space.

Parking parameters are preferably set automatically by an autonomous vehicle or autonomous vehicle coordinator, but may additionally or alternatively be set in any manner (e.g., parking space size parameters may be set automatically based on the autonomous vehicle's knowledge of its own size, while parking duration may be set in response to user input or ridership demand data aggregated at a ridesharing platform or the like).

Parking parameters are preferably received by systems, including one or more processors, of the autonomous vehicle responsible for identifying parking spaces, but may additionally or alternatively be received by any suitable system. For example, an autonomous vehicle may transmit parking parameters to an autonomous vehicle platform, which may include an onboard computer, that aggregates parking sensor data (discussed in later sections); in this example, the autonomous vehicle platform may attempt to identify a potential parking space for the autonomous vehicle based on the parking parameters and/or the parking sensor data. As another example, an autonomous vehicle may transmit parking parameters to another autonomous vehicle, which may then use them to aid in the search for a suitable parking space.

Parking parameters are preferably linked to a description of their importance. For example, some parking parameters may be considered mandatory (i.e., a parking space not meeting those parameters will not be considered), while others may be considered preferable or optional. Parking parameters may be linked to importance in any manner; for example, all parking parameters may be mandatory. As another example, parking parameters may have differing weights used to prioritize the parameters in evaluating parking spaces.

S120 includes transmitting a parking request. S120 functions to enable the autonomous vehicle to inform other entities that the vehicle is searching for a parking space. Depending on the information transmitted and the intended recipient of the parking request, S120 may enable the autonomous vehicle to request assistance for varying aspects of parking. The parking request preferably includes one or more of the parking parameters and optionally, location information of the autonomous vehicle transmitting the request and/or ride or pickup request data.

In a first example, S120 may be used to inform an autonomous vehicle platform or other autonomous vehicles that an autonomous vehicle is seeking parking, so that the autonomous vehicle transmitting the parking request may receive information from the autonomous vehicle platform or an affiliate thereof that may aid the vehicle in finding a parking space. In this example, the autonomous vehicle may transmit the parking request together with the parking parameters to the platform or other vehicles to request, for instance, parking space data (as discussed in S130), or a suggested parking space (e.g., a space that was recently vacated by an autonomous vehicle, or a space that another autonomous vehicle has collected data on showing the space is available or was previously available).

In a second example, S120 may be used to inform a parking lot management system that an autonomous vehicle wishes to park in that parking lot. In this example, the autonomous vehicle may transmit parking parameters as well as payment information (and potentially a maximum price) to the parking lot management system, and receive access to the parking lot (and potentially a designated space) in return.

In a third example, S120 may be used to inform other autonomous vehicles or parking space agent to reserve an available parking space. In such example, the autonomous vehicle may transmit a parking request where the parking request includes parking parameters and an ancillary request to reserve a parking space. Thus, an entity receiving the parking request may assist the autonomous vehicle by reserving an available parking space for the autonomous vehicle making the parking request. For instance, when the receiving entity is a parking agent (e.g., an electronic device that may autonomous or semi-autonomous operate to manage one or more parking spaces), the parking agent may designate an available parking space under the agent's control as being unavailable or reserved. In this way, upon arrival of the autonomous vehicle at the parking space and confirmation of the autonomous vehicle's identity, the parking agent would allow (or release the reservation or the like) the autonomous vehicle to park.

Additionally, or alternatively, when the entity receiving the parking request and reservation request is another autonomous, the other autonomous vehicle may physically reserve an available parking space for the requesting autonomous vehicle. For instance, when the other autonomous vehicle, while travelling or the like, identifies an available parking space fitting the parking parameters of the parking request, the other autonomous vehicle may temporarily occupy the parking space for the requesting autonomous vehicle. In such instance, upon arrival of the requesting autonomous vehicle, the other autonomous vehicle occupying the parking space may move from the parking space thereby allowing the requesting autonomous vehicle to park into the parking space.

Parking requests may be sourced in any manner. For example, an autonomous vehicle may automatically generate a parking request in response to receiving a destination (e.g., from an autonomous vehicle platform or from a passenger), pickup request, or in response to nearing a destination. For instance, once the autonomous vehicle a predetermined proximity or predetermined distance of a destination of the autonomous vehicle, this may automatically trigger the generation of a parking request by the autonomous vehicle and the subsequent transmission to entities in the area of the destination that may assist the autonomous vehicle in acquiring a parking space. As a second example, a parking request may be automatically generated in response to a passenger manually entering a request that the autonomous vehicle park. The request by the passenger may be specific to an instruction for the autonomous vehicle to park (e.g., “AV, find a parking spot”). As a third example, an autonomous vehicle may generate a parking request in response to notification from an external source (e.g., the autonomous vehicle platform, an emergency services platform, a police officer, etc.).

Parking requests are preferably transmitted from an autonomous vehicle, but may additionally or alternatively be transmitted on behalf of an autonomous vehicle from another party. For example, an autonomous vehicle platform may detect that an autonomous vehicle is nearing a parking lot, and automatically request parking from the lot (without first receiving a request from the autonomous vehicle). As another example, a passenger and/or driver of an autonomous vehicle may additionally or alternatively transmit the parking request on behalf of the autonomous vehicle using an electronic device or the like.

Parking requests may be transmitted to any recipient. For example, parking requests may be transmitted to parties able to assist in finding parking (e.g., an autonomous vehicle platform, other autonomous vehicles), parties able to assist in providing access to parking (e.g., parking lot owners), and/or parties able to assist in performing parking (e.g., a passenger or a remote expert capable of controlling the vehicle). Remote experts are preferably as described in U.S. Provisional Application No. 62/274,577, the entirety of which is incorporated by this reference. In some embodiments, the parking request is sent to a virtual parking agent. The virtual parking agent may be embodied in parking management platform (e.g., for managing a parking lot), in one or more parking facilitating devices (e.g., an individual parking meter/device), a centralized parking transaction unit (e.g., a central parking payment processing device), and the like. In such embodiments, for example, the autonomous vehicle may transmit the parking request to a parking agent (e.g., software comprising instructions for facilitating a parking transaction) residing in a parking meter or the like specifically associated with an available parking space. The parking request to the parking meter may include payment information for facilitating a parking transaction for the available parking space.

Parking requests preferably triggers a response from the intended recipient. This response may be information that aids the autonomous vehicle in finding, accessing, and/or parking in parking spaces; additionally or alternatively, the response may trigger a change in the behavior of the intended recipient. For example, a transmitted parking request to an autonomous vehicle may result in the autonomous vehicle modifying its routing to help search for a parking space. As another example, a transmitted parking request to a parking lot owner may result in the lot granting access to the autonomous vehicle (whereas previously it had or would not). In yet another example, transmitting the parking request to an intended recipient may trigger an automatic request for payment information from the autonomous vehicle. In such example, the autonomous vehicle may have or be associated with an electronic wallet (e-wallet) or similar payment information storage device. The autonomous vehicle may select a payment method or payment information for the e-wallet and transmit the payment information to the intended recipient. Additionally, the communication channel between the intended recipient (e.g., virtual parking agent or real person agent) may be encrypted to protect the communication and transmission of payment information. Additionally, or alternatively, if the autonomous vehicle is operating to satisfy a pickup request by an intended passenger or is otherwise, traveling with a rideshare passenger, the autonomous vehicle may select the payment or simply transmit the payment information utilized by the intended passenger or rideshare passenger when the passenger booked a ride request with the autonomous vehicle.

In a variation of a preferred embodiment, a second parking request may be sent if the first parking response is unsuccessful (e.g., there is no response, the response indicates no suitable spaces are available, transmission failure, timeout of the parking request, etc.). The second parking request may include updated location, parking request information, and/or travel information of the autonomous vehicle and thus, the second request may be a modified parking request that takes into consideration in changes in the circumstances of the autonomous vehicle. Alternatively, the initial parking request may simply repeat itself until the request is satisfied or met with a suitable response to the autonomous vehicle.

Parking requests may include any information that may provide context to the parking request or otherwise aid the autonomous vehicle in seeking a desired response to the parking request. For example, parking requests may include parking parameters (as discussed in S110), vehicle identification information (e.g., make, model, and color), requestor identification information (e.g., vehicle, user, owner), access information (e.g., a code or other token that enables the autonomous vehicle to access a parking space), circumstances surrounding the autonomous vehicle (e.g., traffic conditions, estimated time to parking space, passenger location within the vehicle, etc.), and/or payment information.

S130 includes receiving parking space data. S130 functions to enable the autonomous vehicle to receive data (either from an internal source, such as an autonomous vehicle sensor suite, or from an external source, such as another autonomous vehicle or parking agent) that describes parking spaces, availability of one or more parking spaces, or other information related to a parking environment for an autonomous vehicle. Parking space data preferably can be used to ascertain availability and/or accessibility information of parking spaces and actual (e.g., physical) characteristics of parking spaces and/or the surrounding environment of an autonomous vehicle, as opposed to parking parameters—which preferably described desired or required characteristics for parking spaces.

Parking space data may include any data capable of being analyzed to produce information about parking spaces. Thus, the parking space data may include raw or pre-processed data that is obtained by or provided by any entity (including the autonomous vehicle). For example, parking space data may include raw sensor data (e.g., red, green, blue (RGB) camera data, LIDAR data, ultrasound data, GPS data, accelerometer data) of an area that includes parking spaces (e.g., a street). In use, the raw parking space data maybe used by the autonomous vehicle and/or associated autonomous vehicle platform to generate useful parking space information. For example, the autonomous vehicle can use the raw parking data of multiple available parking spaces to generate a heat map of parking spaces in a geographic area surrounding the autonomous vehicle. Such a heat map may display available and unavailable parking spaces, as well as other related parking space data. Additionally, or alternatively, the raw parking space data can be converted into schematics or one or more schematic drawings by the autonomous vehicle or an associated platform. The schematic drawing can be a top-down view of a parking space and a surrounding of the autonomous vehicle together with a rendering of the position of the autonomous vehicle relative to the parking space. This example parking schematic may be used by a passenger or even a remote expert attempting to assist the autonomous vehicle with parking into a parking space.

As a second example, parking space data may include processed sensor data (e.g., RGB camera data and/or LIDAR data with parking spaces linked to map coordinates and tagged or highlighted). The processed sensor data may include data from a subject autonomous vehicle, other autonomous vehicles, and third party sensors (e.g., cameras and the like). The processed sensor data may be augmented with one or more generated technical indicators that may assist the autonomous vehicle to determine whether a parking space is suitable, determine whether any specific or unconventional maneuvers are required for positioning the autonomous vehicle within a parking space, determine or generate a projected position (e.g., a drawing or schematic) of the autonomous vehicle within the space, and the like. In some embodiments, when the autonomous vehicle uses the processed data to generate a drawing showing a projected positioning within a selected parking space, the autonomous vehicle can transmit the drawing for approval by an intended passenger of the autonomous vehicle or a remote expert.

As a third example, parking space data may include parking space descriptive data, which may be pre-existing or predetermined data (e.g., the location of a parking space and/or characteristics of the parking space, whether the parking space is occupied). In addition to the fore-mentioned, the parking space descriptive data may also include time constraints or time usage limitations (e.g., minimum or maximum time or parking limits, etc.), vehicle types and sizes allowed in the parking space, and other attributes that describe the functional limits and not only the physical descriptive attributes of a parking space.

It shall be noted that the raw parking space data, the processed parking space data, and the parking space descriptive data may be used in combination by the autonomous vehicle for assessing and/or identifying a parking space and additionally, determining controls for implementing a parking maneuver into the parking space.

Parking space data may originate from any source; for example, from an autonomous vehicle seeking parking, an autonomous vehicle not seeking parking, an autonomous vehicle platform, a user of an autonomous vehicle or autonomous vehicle platform, a remote expert, a parking space database, a parking agent associated with a parking space, a third party, etc.

S130 may additionally include collecting parking space data S131. S131 functions to enable autonomous vehicles to collect data (e.g., image data or other sensor data) that can be processed and/or analyzed to determine parking space characteristics and/or status.

S131 may include collecting any sensor data at an autonomous vehicle; e.g., camera data, GPS data, IMU data, SONAR data, LIDAR data, microphone data, photodetector data, strain gauge data, pressure data, temperature data, car speed data, and heading data. S131 may additionally or alternatively include collecting any other data at an autonomous vehicle; for example, S131 may include collecting data from a passenger of the autonomous vehicle (e.g., identifying or otherwise characterizing a parking space).

As previously mentioned, S131 may include collecting data at autonomous vehicles even if those vehicles are not searching for parking; such data may be used to provide parking space information to other vehicles or for the collecting vehicles at a later time (e.g., as historical parking space data). The collection of parking space information by the other autonomous vehicles may be triggered by requests from subject autonomous vehicle requiring a parking space or a ridesharing platform or autonomous vehicle coordinator. Additionally, or alternatively, the other autonomous vehicles may continuously or periodically perform parking spaces searches for the purposes of generating parking space heat maps and for learning parking patterns for one or more geographic areas. For instance, based on the continuous and/or periodic collection of parking space information, a heat map or similar reference data may be generated or determine that illustrates when and where parking spaces are likely to be available or not available in the future.

S130 may additionally include processing parking space data S132. S132 preferably includes analyzing and/or processing parking space data to produce parking space characteristics (e.g., size, shape, location, cost, times of availability, etc.) and/or status (e.g., whether the space is occupied, current cost to park in the space).

S132 preferably includes processing parking space data to identify parking spaces using visual indicators of parking spaces. Alternatively, S132 may include processing parking space data in any manner.

For example, S132 may include analyzing image data captured by cameras of an autonomous vehicle to identify occupied parking spaces (e.g., by detecting non-moving vehicles on sides of the road), temporarily occupied parking spaces (e.g., by detecting a person or a dog blocking a parking spot), and unoccupied parking spaces (e.g., by detecting parking meters, by detecting road markers, by detecting unoccupied sections of curb, etc.). As another example, S132 may include analyzing image data to identify and interpret parking signs.

S132 preferably performs image analysis using model-based feature detection (e.g., comparing image data to examples of features known to correspond to parking space characteristics and/or status), but may additionally or alternatively include performing feature detection in any manner (e.g., via machine learning algorithms). Features detected by S132 that may correspond to parking space characteristics and/or status may include, for example, the presence of a parked vehicle, the type of parked vehicle, the status of a parked vehicle (e.g., whether the hazard lights are on, whether doors/trunk are open), the presence of parking meters, the presence of painted parking space demarcations on the street, the presence of signs (e.g., parking signs), the presence of parking tickets on parked vehicles, and the presence of parking enforcement.

Additionally, or alternatively, S132 may include performing processing of parking space data to determine projected openings or projected availabilities of parking spaces, and more particularly, of currently occupied parking spaces. In such embodiments, the parking space data includes meter or time limit information for each associated parking space and/or a duration that parking spaces have been occupied. In such embodiment, the autonomous vehicle is able to determine or estimate, while traveling or otherwise, one or more parking spaces that may become available because a metered or otherwise, parking time limit associated with the one or more parking spaces is scheduled. If the expiry of the parking time limit is schedule near or sufficiently near the time that the autonomous vehicle is scheduled to arrive to an area with the parking space, the autonomous vehicle may flag that currently occupied or unavailable parking space as a possible parking location once the time limit for the parking space has expired.

The parking availability estimations or projections of the autonomous vehicle may also be used by an autonomous vehicle coordinator or the autonomous vehicle to update a heat map of available, unavailable, and soon-to-be available parking spaces. These spaces may be illustrated on a heat map with three distinct indicators (e.g., green, red, and yellow, respectively). The heat map, either updated or not, may be propagated to the other autonomous vehicles in a fleet of autonomous vehicles.

S132 may additionally or alternatively include performing any other type of processing to enable analysis of parking space data. For example, S132 may include performing image distortion correction and/or image filtering. As another example, S132 may include performing optical character recognition (OCR) on parking signs (or any other signage) to receive a transcription of the sign and then analyzing the text (e.g., by comparing to a known database of parking sign text components, by running the text through a trained machine learning algorithm, etc.) to produce an interpretation of the sign. Alternatively, S132 may include interpreting parking signs in any manner (e.g., comparing images of parking signs to known images of parking signs, requesting a human to interpret parking signs, etc.).

S132 may additionally include performing sensor fusion on parking space data captured by autonomous vehicles (e.g., associating LIDAR data with RGB data and GPS data) at any point during data processing.

Note that S132 may be performed in part or in full at any electronic device capable of performing data processing. For example, camera data captured by an autonomous vehicle may be processed completely using an onboard computer or may be transmitted to an autonomous vehicle platform for some or all processing.

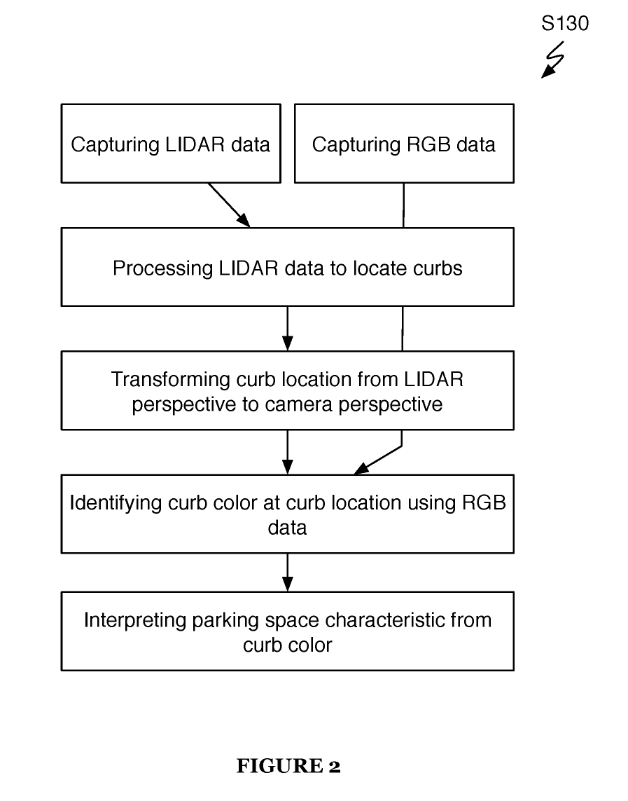

In one implementation of a preferred embodiment, S131 includes collecting LIDAR and RGB camera data and S132 includes processing the LIDAR and RGB camera data to identify and classify curbs, as shown in FIG. 2. In this implementation, S132 preferably includes performing feature identification on LIDAR data to detect the presence and location of curbs (e.g., by detecting a change in height of the street along the edge of a road), using a calibration between the LIDAR data and RGB camera data to find RGB data corresponding to the curbs (e.g., using a known transformation between the perspective of the LIDAR sensor and the camera), and using the RGB data (e.g., the color) to classify the curb type and to identified any items or markings (e.g., stripes, etc.) having color appearing on or near the curb and maybe evening on a surface of a parking space. This implementation may be substantially more effective than RGB image analysis alone at identifying and classifying parking spaces based on curb color (e.g., green curbs corresponding to twenty-minute limit, red curbs corresponding to no parking, etc.).

S130 may include utilizing collected and received data together in any manner. For example, an autonomous vehicle may receive indication of an available parking space at a particular location (e.g., from an autonomous vehicle platform), travel to that parking space, and find that the parking space is now occupied (e.g., by collecting sensor data showing another vehicle in that space). After finding this, the autonomous vehicle may search the surrounding area (using local sensor data) to find another available space or receive parking availability from a parking agent associated with parking spaces after sending a parking request to local parking agents in the vicinity of the autonomous vehicle.

S130 may additionally or alternatively include updating parking space data (e.g., linked to location and stored in an autonomous vehicle platform) based on sensor data captured by autonomous vehicles (in the previous example, this might include noting that the parking space previously indicated is now occupied and potentially what vehicle is occupying it). This parking space data update may be used by an autonomous vehicle coordinator to update a heat map of available and unavailable parking spaces.

S130 may include filtering or otherwise prioritizing parking space data based on parking parameters, responses to parking requests, and/or any other suitable information. In the previous example, S130 may include navigating to a space only after verifying that the space meets parking parameters set by the autonomous vehicle, for instance.

S130 may additionally or alternatively include generating predicted parking space availability (or cost, or any other parking space status) based on historical data captured by autonomous vehicles and/or other sources, or any other suitable data. For example, S130 may include generating a parking space heatmap that could be used (e.g., in absence of more accurate data) to aid an autonomous vehicle in estimating a good location to park. Predicted parking space status may be generated based on any suitable criteria (e.g., historical space availability, traffic, time of day, etc.). As another example, predicted parking space availability maybe determined by using sensor data to determine that a vehicle is leaving a parking spot, or that a number of vehicles are leaving a parking lot or garage. As a third example, predicted parking space availability may be provided by another party, such as a parking garage that tracks its usage.

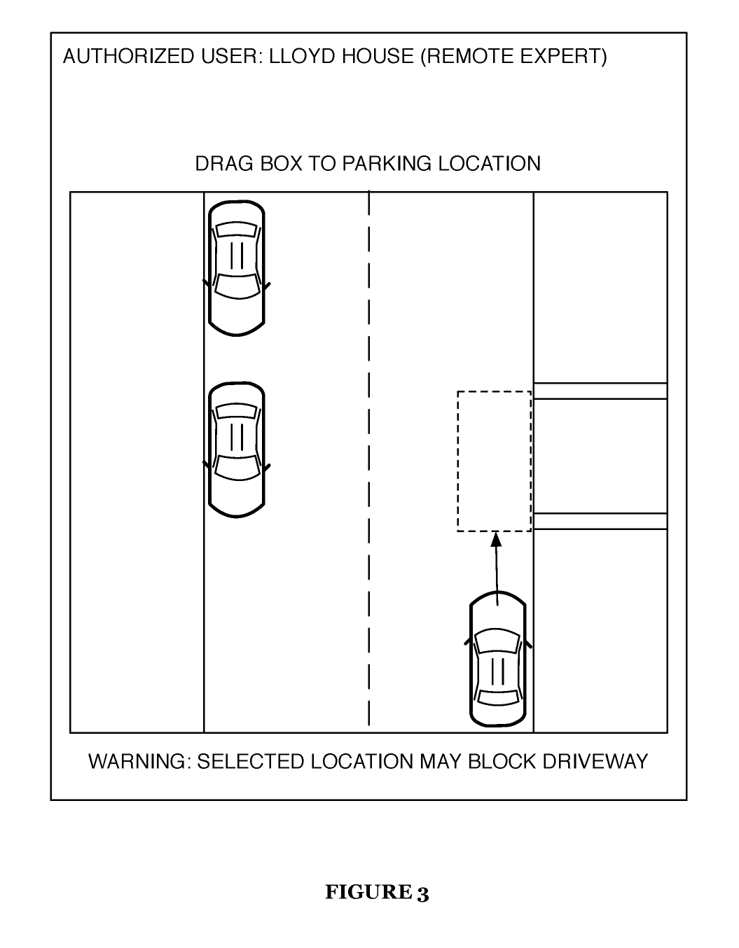

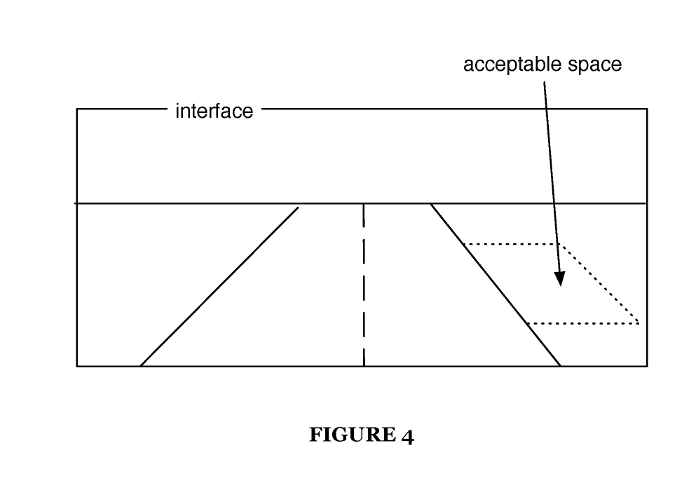

In a variation of a preferred embodiment, S130 includes receiving parking space data from a passenger and/or another human (e.g., a remote expert). For example, a passenger or remote expert may be asked to select a parking space using an interface on an electronic device (e.g., the passenger's smartphone, a touchscreen inside the vehicle), as shown in FIG. 3. As another example, a passenger may be asked to take a picture (or simply point a camera at) a location they would like to park. In this example, the passenger may do so with an augmented reality (AR) interface that highlights acceptable parking spaces (e.g., parking spaces of a certain size), as shown in FIG. 4.

In one example embodiment, S130 functions to provide augmented reality capabilities to a user device (e.g., a mobile computing device or the like) that allows an intended passenger to livestream their environment with a computer-generated overlay that is superimposed or superposed over a display of the livestreamed environment. The overlay, in some embodiments, may provide display and/or provide information from the autonomous vehicle's perspective. That is, the overlay would demonstrate a manner in which the autonomous vehicle would interpret the livestreamed environment surrounding the intended passenger including the identifiable objects and traffic elements (e.g., lanes, traffic lights, curbs, bus lanes) in the environment, the location, and the like. For instance, if in the livestream environment, an available open parking space is a best position for the autonomous vehicle to stop and park temporarily to pick up the intended passenger, the overlay may show this position as green area together with an indication of optimal parking location. Alternatively, any location in the livestream which includes a bus lane, an obstruction (e.g., another vehicle, an object, etc.) that cannot be used to park, the augmented reality overlay would illustrate those positions as red indicating suboptimal or unavailable locations for parking.

The augmented reality overlay of S130 may additionally indicate one or more movements that an intended passenger can make to better position himself for pickup at a parked location of an autonomous vehicle by creating a marker, such as a pinpoint, and/or providing arrows or other instructional indicators that direct the intended passenger to a parking location of the autonomous vehicle.

Additionally, or alternatively, the livestream and augmented reality overlay of the intended passenger's mobile computing device may be communicated or shared with the autonomous vehicle. The autonomous vehicle may be able to compare the augmented reality (AR) and livestream mapping of the mobile computing device of the intended passenger to its own mapping (e.g., three-dimensional map) to determine a parking location. Thus, based on finding overlaps between the AR livestream mapping and the mapping and parking space data of the autonomous vehicle, the autonomous vehicle may better localize a suitable and convenient parking location when traveling to satisfy a ride or pickup request.

S140 includes parking the autonomous vehicle into a selected parking space. S140 functions to select a parking space for the autonomous vehicle to park in, generate controls for maneuvering the autonomous vehicle into the parking space, and navigate the vehicle into the parking space based on the controls.

S140 preferably includes selecting parking spaces based on the extent to which parking parameters of an autonomous vehicle are met by a parking space (determined by analysis of parking space data). As described previously, parking parameters are preferably linked to a description of their importance. S140 may include evaluating parking spaces (identified and characterized by parking space data) using parking parameters in any manner. For example, S140 may include calculating a parking space score (e.g., a weighted sum of the extent to which the space meets parking parameters) that must be above or below a threshold level for the autonomous vehicle to park in a parking space. As another example, S140 may include calculating parking space scores for a number of parking spaces and using the scores to rank a set of available parking spaces.

After selecting a parking space, S140 may include generating autonomous vehicle controls or control parameters based on the selected parking space and the parking space data associated with the selected parking space. For instance, whether the parking space involves or does not involve a curb may influence the controls relating to the angles at which the autonomous vehicle may turn to achieve a successful parking maneuver within the selected parking space. Other factors, such as the size and shape of the parking space, as well as whether there are other vehicles next or near the parking space may also influence the controls generation process. This additional information, of course, may be obtained from the sensors available to the autonomous vehicle.

Once the autonomous vehicle controls for parking the autonomous vehicle are generated, S140 may include executing the controls and performing any action necessary (or desired) to enable the autonomous vehicle to park legally within the selected parking space. For example, S140 may include sending a request to park and/or payment information (as described in S120). As another example, S140 may include sending a request to a third party to facilitate parking (e.g., a request to a passenger or another person to put money into a parking meter). As a third example, S140 may include requesting that a third party reserve the space (e.g., by occupying the space).

S140 preferably includes parking the autonomous vehicle automatically, but may additionally or alternatively include enabling manual parking of the autonomous vehicle (e.g., by a passenger, remote expert, and/or other entity).

The method of the preferred embodiment and variations thereof can be embodied and/or implemented at least in part as a machine configured to receive a computer-readable medium storing computer-readable instructions. The instructions are preferably executed by computer-executable components preferably integrated with an autonomous vehicle platform. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments of the invention without departing from the scope of this invention defined in the following claims.

We claim:

1. A system for autonomous vehicle parking, the system comprising:
an autonomous vehicle comprising a sensor suite and an onboard computer, wherein:
the autonomous vehicle is configured to identify parking parameters for parking the autonomous vehicle;
the sensor suite is configured to obtain parking space data of one or more available parking spaces;
the onboard computer is configured to (i) identify an available parking space to park the autonomous vehicle from the one or more available parking spaces (ii) generate autonomous vehicle controls for parking the autonomous vehicle based on the parking parameters and parking space data of the available parking space, and (iii) implementing the autonomous vehicle controls to park the autonomous vehicle at the available parking space.

2. The system of claim 1, wherein identifying parking parameters comprise receiving the parking parameters from a remote autonomous vehicle coordinator, wherein the parking parameters are generated based on a pickup request by an intended passenger of the autonomous vehicle or based on a predetermined schedule for parking autonomous vehicles, wherein the parking parameters comprise criteria used by the autonomous vehicle to locate or evaluate one or more potential parking spaces.

3. The system of claim 1, wherein the sensor suite comprises:
a light detection and ranging (LIDAR) system to detect physical attributes of the available parking space;
at least one RGB camera to detect colored markings associated with the available parking space;
one or more detectors, implemented using the onboard computer, to identify signage associated with the available parking space, wherein, in response to detecting a sign, interpreting information provided by the detected sign.

4. The system of claim 1, wherein the autonomous vehicle is configured to:
transmit a parking request to one or more external entities, wherein the parking request comprises the parking parameters and a request to assist the autonomous vehicle in locating the one or more available parking spaces, wherein the parking parameters include an expected geographic area for parking, an expected duration of parking, and attributes of the autonomous vehicle.

5. A method for autonomous vehicle parking, the method comprising:
identifying parking parameters for parking an autonomous vehicle;
obtaining parking space data of one or more parking spaces;
identifying an available parking space of the one or more parking spaces for parking the autonomous vehicle;
determining autonomous vehicle controls for controlling the autonomous vehicle to park at the identified available parking space associated with the parking space data;
implementing the autonomous vehicle controls for parking the autonomous vehicle in the available parking space.

6. The method of claim 5, wherein identifying parking parameters includes:
receiving a request for pickup by an intended passenger, wherein the request for pickup comprises a pickup location and a pickup time for picking up the intended passenger; and
determining that parking is required based on the pickup location and the pickup time for the request for pickup.

7. The method of claim 6, wherein in response to determining that parking is required, identifying:
(i) an expected parking area, wherein the expected parking area comprises a geographic limited area that is defined by a predetermined radius surround the pickup location or a generated area surrounding the pickup location;
(ii) one or more possible parking locations in the expected parking area, and
(iii) an expected parking duration for the autonomous vehicle.

8. The system of claim 5, further comprising:
identifying, by a plurality of disparate autonomous vehicles, available parking spaces in one or more geographic areas; and
in response to receiving a parking request from the autonomous vehicle, transmitting to the autonomous vehicle parking parameters comprising available parking spaces in the one or more geographic areas.

9. The method of claim 5, further comprising:
transmitting a parking request to one or more external parking facilitators;
receiving a response from at least one of the one or more external parking facilitators, wherein the response comprises information relating to the parking space, wherein determining the autonomous vehicle controls is based on the response from the one or more external parking facilitators and the parking space data.

10. The method of claim 9, wherein the one or more external parking facilitators comprise a virtual parking agent residing in a parking transaction device associated with the parking space, wherein the parking request is processed by the virtual parking agent and the virtual parking agent assists the autonomous vehicle in securing the parking space.

11. The method of claim 9, wherein the one or more external parking facilitators comprise a parking lot management system, wherein the parking request provides (i) an indication that the autonomous vehicle desires to park in a parking space associated with a parking lot managed by the parking lot management system and (ii) payment information, and
wherein the parking lot management system interacts with the autonomous vehicle to facilitate parking by the autonomous vehicle in the parking space.

12. The method of claim 5, wherein receiving parking space data includes:
using one or more sensors of the autonomous vehicle to identify one or more physical attributes of the parking space;
wherein identifying the parking space to park is further based on the one or more physical attributes of the parking space.

13. The method of claim 9, wherein the parking request comprises a request to reserve an available parking space for the autonomous vehicle, wherein:
if request to reserve the available parking space is satisfied by a virtual parking agent or parking management system, indicating by the virtual parking agent or the parking management system that the available parking space is unavailable or is reserved thereby preventing any other vehicle from parking in the available parking space, or
if the request to reserve the available parking space is satisfied by another autonomous vehicle, temporarily obstructing or parking at the available space until the autonomous vehicle arrives to park at the available parking space.

14. The method of claim 5, wherein the autonomous vehicle is associated with an electronic wallet comprising payment information, wherein the autonomous vehicle is configured to select and transmit payment information from the electronic wallet for facilitating a transaction for the available parking space.

15. The method of claim 14, wherein the payment information of the electronic wallet includes payment information associated with an intended or current ridesharing passenger, wherein the autonomous vehicle is configured to select the payment information of the intended or current ridesharing passenger to facilitate the transaction for the available parking space.

16. The method of claim 5, wherein identifying the available parking space comprises:
using sensor data obtained by the autonomous vehicle to:
determine that the available space is unoccupied;
determine that the available space is sufficient to accommodate the autonomous vehicle; and
determine an allowed duration for parking at the available parking space is sufficient to satisfy a required parking duration for the autonomous vehicle; and
wherein parking the autonomous vehicle in the available space is based on determining that (i) the available space is unoccupied, (ii) the available space is sufficient to accommodate the autonomous vehicle, and (iii) that the allowed duration for parking is sufficient to satisfy the required parking duration.

17. The method of claim 8, wherein obtaining parking space data of one or more parking spaces includes using one or more sensors of the autonomous vehicle to collect attributes and parking space information about the one or more parking spaces.

18. The method of claim 17, further comprising:
using the parking space data from the plurality of autonomous vehicles and the parking space data obtained by the one or more sensors of the autonomous vehicle to generate a heat map of parking spaces in a geographic area, wherein the heat map of parking spaces indicates available and unavailable parking spaces in the geographic area, as determined using the parking space data.

19. The method of claim 18, wherein identifying the available parking space is further based on selecting the available parking space from the available parking spaces in the heat map.
